(19) United States
(12) Patent Application Publication
(10) Pub. No.: US 2025/0269864 A1
(43) Pub. Date: Aug. 28, 2025

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicant: TOYOTA JIDOSHA KABUSHIKI KAISHA, Toyota-shi (JP)

(72) Inventor: Sawa Higuchi, Toyota-shi (JP)

(73) Assignee: TOYOTA JIDOSHA KABUSHIKI KAISHA, Toyota-shi (JP)

(21) Appl. No.: 19/041,017

(22) Filed: Jan. 30, 2025

(30) Foreign Application Priority Data
Feb. 26, 2024 (JP) 2024-026406

(51) Int. Cl. B60W 50/10; B60W 50/14

(52) U.S. Cl. CPC B60W 50/10; B60W 50/14

(57) ABSTRACT

A vehicle driving assistance apparatus executes a driving assistance control to assist a driver of an own vehicle in driving operations. When an erroneous operation probability is equal to or less than a predetermined erroneous operation probability upon detecting a change operation performed by the driver to request a change in an execution state of the driving assistance control, the apparatus changes the execution state as requested by the detected change operation. The erroneous operation probability indicates a possibility that the driver erroneously performed the change operation, and increases as the possibility increases. When the erroneous operation probability is greater than the predetermined erroneous operation probability upon detecting the change operation, the apparatus does not change the execution state or perform a more gradual change in the execution state than requested by the detected change operation.

### CROSS-REFERENCE TO RELATED APPLICATIONS

This application claims priority to Japanese patent application No. JP 2024-026406 filed on Feb. 26, 2024, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus which executes a driving assistance control to assist a driving operation by a driver of a vehicle. In such a vehicle driving assistance apparatus, various switches which the driver operates to start and stop the driving assistance control are provided on a steering wheel of the vehicle. When such switches are provided on the steering wheel, it is easy for the driver to operate those switches, but there is a possibility that the driver may operate the switches by mistake. Therefore, for example, there is also known a vehicle driving assistance apparatus which is configured to determine whether or not it is permitted to start the driving assistance control based on a type of the road on which the vehicle is moving when the switch for starting the driving assistance control is operated (see, for example, JP 2009-143354 A). This conventional vehicle driving assistance apparatus is configured not to start the driving assistance control when it is not permitted to start the driving assistance control.

The conventional vehicle driving assistance apparatus determines whether or not it is permitted to start the driving assistance control based only on the type of the road on which the vehicle is currently moving. Therefore, the conventional vehicle driving assistance apparatus may not start the driving assistance control even when the driver does not erroneously operate the switch.

### SUMMARY

An object of the present invention is to provide a vehicle driving assistance apparatus, a vehicle driving assistance method, and a storage medium storing a vehicle driving assistance program which can change an execution state of the driving assistance control while taking into consideration the possibility that the operation requesting the change in the execution state of the driving assistance control was erroneously performed by the driver.

A vehicle driving assistance apparatus according to the present invention comprises an electronic control unit which executes a driving assistance control to assist a driver of an own vehicle in driving operations. When (i) the electronic control unit detects a change operation performed by the driver of the own vehicle to request a change in an execution state of the driving assistance control, and (ii) an erroneous operation probability is equal to or less than a predetermined erroneous operation probability, the electronic control unit is configured to change the execution state as requested by the detected change operation. The erroneous operation probability indicates a possibility that the driver of the own vehicle erroneously performed the change operation, and increases as the possibility increases. When the erroneous operation probability is greater than the predetermined erroneous operation probability upon detecting the change operation, the electronic control unit is configured not to change the execution state or perform a more gradual change in the execution state than requested by the detected change operation.

According to the vehicle driving assistance apparatus of the present invention, whether or not to change the execution state of the driving assistance control is determined based on the erroneous operation probability, or a manner of changing the execution state of driving assistance control is adjusted based on the erroneous operation probability. The erroneous operation probability indicates the possibility that the operation requesting to change the execution state of the driving assistance control is erroneously performed by the driver. Therefore, the execution state of the driving assistance control is changed while taking into consideration the possibility that the driver erroneously performed the operation requesting to change the execution state of the driving assistance control.

In the vehicle driving assistance apparatus according to an aspect of the present invention, the erroneous operation probability may decrease as a driver operation frequency increases. In this aspect, the driver operation frequency may be the frequency with which the same change operation as the currently detected change operation was performed in the past by the driver of the own vehicle on the road of the same type as the road on which the own vehicle is moving at the time of currently detecting the change operation. Alternatively, the erroneous operation probability may decrease as a market operation frequency increases. The market operation frequency may be the frequency with which an operation requesting a change of the same type as the change requested by the currently detected change operation was performed in the past by a driver of another vehicle on the road of the same type as the road on which the own vehicle is moving at the time of currently detecting the change operation. Alternatively, the erroneous operation probability may decrease as a recommendation degree increases. The recommendation degree may be the degree to which the change requested by the currently detected change operation is recommended on the road on which the own vehicle is moving at the time of currently detecting the change operation.

According to the vehicle driving assistance apparatus of this aspect of the present invention, the execution state of the driving assistance control is changed based on at least one of the driver operation frequency, the market operation frequency, and the recommendation degree.

In the vehicle driving assistance apparatus according to another aspect of the present invention, the electronic control unit may be configured to, when the electronic control unit determines not to change the execution state in response to the erroneous operation probability being greater than the predetermined erroneous operation probability upon detecting the change operation, perform an approval request notification to the driver of the own vehicle to request an approval for changing the execution state. In this aspect, the electronic control unit may be configured to, when the driver of the own vehicle receiving the approval request notification approves the change in the execution state, change the execution state.

According to the vehicle driving assistance apparatus of this aspect of the present invention, the execution state of the driving assistance control is changed when the driver of the own vehicle approves the change in the execution state even when it is determined not to change the execution state.

In the vehicle driving assistance apparatus according to further another aspect of the present invention, the erroneous operation probability may decrease as a driver approval frequency increases. The driver approval frequency may be the frequency with which the driver of the own vehicle approved the change in the past in response to the approval request notification performed in response to detecting the same operation as the currently detected change operation on the roads of the same type as the road on which the own vehicle is moving at the time of currently detecting the change operation.

According to the vehicle driving assistance apparatus of this aspect of the present invention, the execution state of the driving assistance control is changed based on the driver approval frequency.

In the vehicle driving assistance apparatus according to further another aspect of the present invention, the electronic control unit may be configured to notify the driver of the own vehicle that the execution state will be changed when the electronic control unit determines to perform the more gradual change in the execution state than requested by the detected change operation.

According to the vehicle driving assistance apparatus of this aspect of the present invention, when the erroneous operation probability is relatively high, and it is determined to change the execution state, the driver of the own vehicle is notified that the execution state will be changed. This makes it possible to prevent the driver of the own vehicle from feeling uneasy.

In the vehicle driving assistance apparatus according to further another aspect of the invention, the electronic control unit may be configured to, when (i) the detected change operation is the operation requesting a change in a control amount for the own vehicle by the driving assistance control, and (ii) the electronic control unit determines to perform the more gradual change in the execution state than requested by the detected change operation upon detecting the change operation, change the control amount to a smaller degree than requested by the detected change operation.

According to the vehicle driving assistance apparatus of this aspect of the present invention, when the erroneous operation probability is relatively high, an amount of change in the control amount is small. This makes it possible to prevent the driver of the own vehicle from feeling uneasy.

In the vehicle driving assistance apparatus according to further another aspect of the present invention, the electronic control unit may be configured to, when the electronic control unit determines not to change the execution state in response to the erroneous operation probability being greater than the predetermined erroneous operation probability upon detecting the change operation, perform a change notification to notify the driver of the own vehicle that the execution state will be changed. In this aspect, the electronic control unit may be configured to, when a predetermined time elapses since the change notification is performed, change the execution state.

According to the vehicle driving assistance apparatus of this aspect of the present invention, when the erroneous operation probability is relatively high, the driver of the vehicle is notified that the execution state will be changed, and then the execution state is changed when the predetermined time elapses. This makes it possible to prevent the driver of the own vehicle from feeling uneasy.

A vehicle driving assistance method according to the present invention is a method for executing a driving assistance control to assist a driver of an own vehicle in driving operations. The vehicle driving assistance method comprises a step of, when an erroneous operation probability is equal to or less than a predetermined erroneous operation probability upon detecting a change operation performed by the driver of the own vehicle to request a change in an execution state of the driving assistance control, changing the execution state as requested by the detected change operation. The erroneous operation probability indicates a possibility that the driver of the own vehicle erroneously performed the change operation, and increases as the possibility increases. The vehicle driving assistance method comprises a step of, when the erroneous operation probability is greater than the predetermined erroneous operation probability upon detecting the change operation, not changing the execution state or perform a more gradual change in the execution state than requested by the detected change operation.

For the reasons described above, according to the vehicle driving assistance method of the present invention, the execution state of the driving assistance control is changed while taking into consideration the possibility that the driver erroneously performed the operation requesting to change the execution state of the driving assistance control.

A computer-readable storage medium according to the present invention stores a vehicle driving assistance program which executes a driving assistance control to assist a driver of an own vehicle in driving operations. The vehicle driving assistance program is configured to, when an erroneous operation probability is equal to or less than a predetermined erroneous operation probability upon detecting a change operation performed by the driver of the own vehicle to request a change in an execution state of the driving assistance control, and (ii), change the execution state as requested by the detected change operation. The erroneous operation probability indicates a possibility that the driver of the own vehicle erroneously performed the change operation, and increases as the possibility increases. The vehicle driving assistance program is configured to, when the erroneous operation probability is greater than the predetermined erroneous operation probability upon detecting the change operation, not change the execution state or perform a more gradual change in the execution state than requested by the detected change operation.

For the reasons described above, according to the vehicle driving assistance program of the present invention, the execution state of the driving assistance control is changed while taking into consideration the possibility that the driver erroneously performed the operation requesting to change the execution state of the driving assistance control.

The vehicle driving assistance apparatus according to the present invention may be configured to learn the driver operation frequency and the market operation frequency, and may be configured to perform the learning using AI technology such as so-called machine learning or deep learning.

The components of the present invention are not limited to embodiments of the present invention described below with reference to the drawings. Other objects, other features, and associated advantages of the present invention will be easily understood from description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a steering wheel of an own vehicle.

FIG. 3 is a flow chart showing a routine executed by the vehicle driving assistance apparatus according to the embodiment of the present invention.

FIG. 4 is a diagram showing a scene where a preceding vehicle is present ahead of the own vehicle.

FIG. 5 is a diagram showing a scene where no preceding vehicle is present ahead of the own vehicle.

FIG. 6 is a diagram showing erroneous operation probabilities for each combination of the type of road on which the own vehicle is moving at the time of detecting a change operation and the type of change operation.

### DETAILED DESCRIPTION

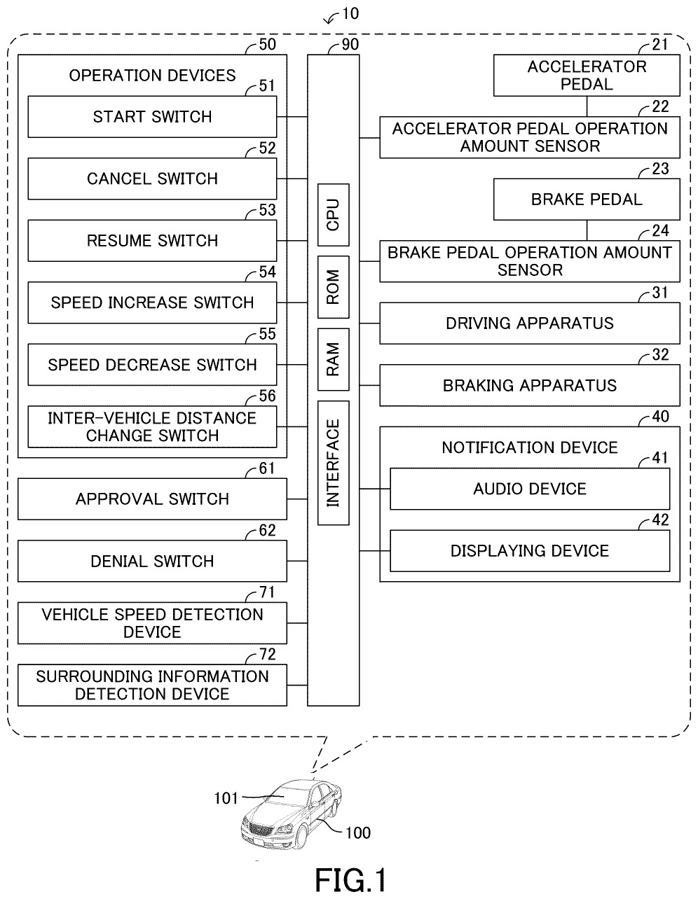

Below, a vehicle driving assistance apparatus, a vehicle driving assistance method, and a vehicle driving assistance program according to an embodiment of the present invention will be described with reference to the drawings. FIG. 1 shows the vehicle driving assistance apparatus 10 according to the embodiment of the present invention. The vehicle driving assistance apparatus 10 is mounted on an own vehicle 100. The vehicle driving assistance apparatus 10 will be described below using as an example a case where an operator of the own vehicle 100 is a person who rides in the own vehicle 100 and drives the own vehicle 100 (i.e., a driver of the own vehicle 100).

However, the operator of the own vehicle 100 may be a person who drives the own vehicle 100 remotely without riding in the own vehicle 100 (i.e., a remote operator of the own vehicle 100). When the operator of the own vehicle 100 is the remote operator, the vehicle driving assistance apparatus 10 is mounted on the own vehicle 100 and on a remote operation facility installed outside the own vehicle 100 to remotely drive the own vehicle 100, and functions of the vehicle driving assistance apparatus 10 described below are shared between the vehicle driving assistance apparatus 10 mounted on the own vehicle 100 and the vehicle driving assistance apparatus 10 mounted on the remote operation facility.

The vehicle driving assistance apparatus 10 is equipped with a control device that executes a driving assistance control to assist the driver of the own vehicle 100 in driving operations (for example, acceleration, deceleration, steering, etc. of the own vehicle 100).

As shown in FIG. 1, the vehicle driving assistance apparatus 10 is equipped with an ECU (electronic control device) 90 as the control device. The ECU 90 has a microcomputer as its main component. The microcomputer includes a CPU, a storage medium such as a ROM, a RAM, and a non-volatile memory, and an interface, etc. The CPU is configured to realize various functions by executing instructions, programs, or routines stored in the storage medium. In particular, in this embodiment, the vehicle driving assistance apparatus 10 stores programs that realize various controls executed by the vehicle driving assistance apparatus 10 in the storage medium.

In this embodiment, the vehicle driving assistance apparatus 10 includes only one ECU 90, but it may also be configured to include multiple ECUs, with each ECU sharing the functions of the vehicle driving assistance apparatus 10 described below.

The vehicle driving assistance apparatus 10 may also be configured to update the programs stored in the storage medium through wireless communication (for example, Internet communication) with an external device.

The own vehicle 100 is equipped with an accelerator pedal 21, an accelerator pedal operation amount sensor 22, a brake pedal 23, a brake pedal operation amount sensor 24, a driving apparatus 31, and a braking apparatus 32.

The accelerator pedal operation amount sensor 22 is electrically connected to the ECU 90. The vehicle driving assistance apparatus 10 acquires an operation amount of the accelerator pedal 21 as an accelerator pedal operation amount AP by the accelerator pedal operation amount sensor 22.

The brake pedal operation amount sensor 24 is electrically connected to the ECU 90. The vehicle driving assistance apparatus 10 acquires an operation amount of the brake pedal 23 as a brake pedal operation amount BP by the brake pedal operation amount sensor 24.

The driving apparatus 31 outputs a driving force to be applied to the own vehicle 100. The driving apparatus 31 is electrically connected to the ECU 90. The vehicle driving assistance apparatus 10 controls an operation of the driving apparatus 31 to control the driving force to be applied to the own vehicle 100. When the vehicle driving assistance apparatus 10 is not executing the driving assistance control described below, the vehicle driving assistance apparatus 10 controls the driving force output from the driving apparatus 31 based on the accelerator pedal operation amount AP.

The braking apparatus 32 applies a braking force to the own vehicle 100. The braking apparatus 32 is electrically connected to the ECU 90. The vehicle driving assistance apparatus 10 controls the braking force applied to the own vehicle 100 by controlling an operation of the braking apparatus 32. When the vehicle driving assistance apparatus 10 is not executing the driving assistance control described below, the vehicle driving assistance apparatus 10 controls the braking force applied to the own vehicle 100 from the braking apparatus 32 based on the brake pedal operation amount BP.

Furthermore, the own vehicle 100 is equipped with a notification device 40. The notification device 40 provides various notifications to the driver of the own vehicle 100. In this embodiment, the notification device 40 includes an audio device 41 and a displaying device 42.

The audio device 41 is, for example, a device including a speaker. The audio device 41 is electrically connected to the ECU 90. The vehicle driving assistance apparatus 10 provides various notifications to the driver of the own vehicle 100 by outputting various sounds from the audio device 41.

The displaying device 42 is, for example, a device including a display. The displaying device 42 is electrically connected to the ECU 90. The vehicle driving assistance apparatus 10 provides various notifications to the driver of the own vehicle 100 by displaying various images on the displaying device 42.

An approval request notification, a start notification, a stop notification, a change notification, etc., which will be described later, are provided by the notification device 40. That is, the approval request notification, the start notification, the stop notification, the change notification, etc. are provided by audio notifications from the audio device 41 and/or image notifications from the displaying device 42.

Furthermore, the own vehicle 100 is equipped with a start switch 51, a cancel switch 52, a resume switch 53, a speed increase switch 54, a speed decrease switch 55, and an inter-vehicle distance change switch 56 as operation devices 50.

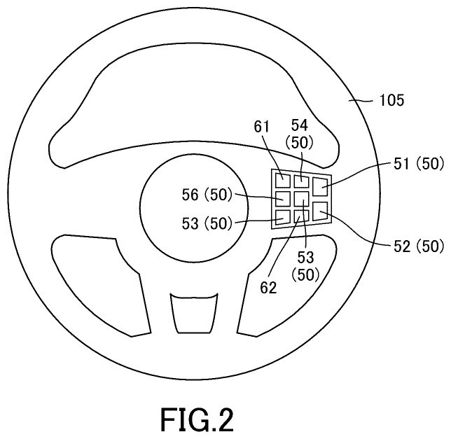

The operation devices 50 are operated by the driver to request the vehicle driving assistance apparatus 10 to change an execution state of the driving assistance control (for example, a following cruise control and a constant speed cruise control, which will be described later). The operation devices 50 are provided in locations that are easy for the driver of the own vehicle 100 to operate. In this embodiment, the operation devices 50 are attached to a steering wheel 105 of the own vehicle 100 as shown in FIG. 2.

The start switch 51 is operated by the driver. The start switch 51 is electrically connected to the ECU 90. When the start switch 51 is operated, the vehicle driving assistance apparatus 10 detects a start operation as a change operation. The start operation requests the vehicle driving assistance apparatus 10 to start the driving assistance control.

The cancel switch 52 is operated by the driver. The cancel switch 52 is electrically connected to the ECU 90. When the cancel switch 52 is operated, the vehicle driving assistance apparatus 10 detects a cancel operation as the change operation. The cancel operation requests the vehicle driving assistance apparatus 10 to cancel or stop the driving assistance control.

The resume switch 53 is operated by the driver. The resume switch 53 is electrically connected to the ECU 90. When the resume switch 53 is operated, the vehicle driving assistance apparatus 10 detects a resume operation as the change operation. The resume operation requests the vehicle driving assistance apparatus 10 to resume the driving assistance control.

The speed increase switch 54 is operated by the driver. The speed increase switch 54 is electrically connected to the ECU 90. When the speed increase switch 54 is operated, the vehicle driving assistance apparatus 10 detects a speed increase operation as the change operation. The speed increase operation requests the vehicle driving assistance apparatus 10 to increase a set vehicle speed Vset in the driving assistance control.

The speed decrease switch 55 is operated by the driver. The speed decrease switch 55 is electrically connected to the ECU 90. When the speed decrease switch 55 is operated, the vehicle driving assistance apparatus 10 detects a speed decrease operation as the change operation. The speed decrease operation requests the vehicle driving assistance apparatus 10 to decrease the set vehicle speed Vset in the driving assistance control.

The inter-vehicle distance change switch 56 is operated by the driver. The inter-vehicle distance change switch 56 is electrically connected to the ECU 90. When the vehicle driving assistance apparatus 10 detects an inter-vehicle distance operation as the change operation. The inter-vehicle distance operation requests the vehicle driving assistance apparatus 10 to change a set inter-vehicle distance Dset in the driving assistance control.

Furthermore, the own vehicle 100 is equipped with an approval switch 61 and a denial switch 62. In this embodiment, the approval switch 61 and the denial switch 62 are also attached to the steering wheel 105 of the own vehicle 100 as shown in FIG. 2.

The approval switch 61 is operated by the driver. The approval switch 61 is electrically connected to the ECU 90. When the approval switch 61 is operated, the vehicle driving assistance apparatus 10 detects an approval operation. The approval operation is an operation in which the driver approves a change in the execution state of the driving assistance control notified by an approval request notification described later.

The denial switch 62 is also operated by the driver. The denial switch 62 is electrically connected to the ECU 90. When the denial switch 62 is operated, the vehicle driving assistance apparatus 10 detects a denial operation. The denial operation is an operation in which the driver denies the change in the execution state of the driving assistance control notified by the approval request notification described later.

Furthermore, the own vehicle 100 is equipped with a vehicle speed detection device 71 and a surrounding information detection device 72.

The vehicle speed detection device 71 detects a moving speed of the own vehicle 100. The vehicle speed detection device 71 includes, for example, wheel speed sensors provided on each wheel of the own vehicle 100. The vehicle speed detection device 71 is electrically connected to the ECU 90. The vehicle driving assistance apparatus 10 acquires the moving speed of the own vehicle 100 as an own vehicle speed V by the vehicle speed detection device 71.

The surrounding information detection device 72 acquires information on surroundings of the own vehicle 100 as surrounding information IS. The surrounding information detection device 72 includes, for example, electromagnetic wave sensors such as radar sensors and image sensors such as camera sensors.

The surrounding information detection device 72 is electrically connected to the ECU 90. The vehicle driving assistance apparatus 10 acquires data on objects (i.e., object information IO) present around the own vehicle 100 as the surrounding information IS by the surrounding information detection device 72. The vehicle driving assistance apparatus 10 also acquires image data (i.e., image information IC) on an area ahead of the own vehicle 100 as the surrounding information IS by the surrounding information detection device 72.

### <Operation of Vehicle Driving Assistance Apparatus>

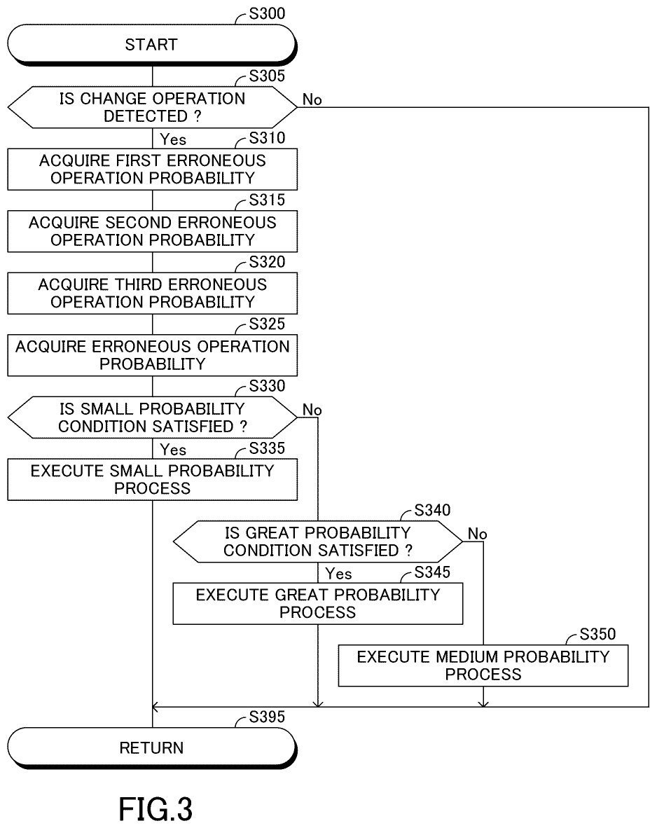

Next, an operation of the vehicle driving assistance apparatus 10 will be described. The vehicle driving assistance apparatus 10 is configured to execute a routine shown in FIG. 3 at predetermined time intervals, and when predetermined conditions are satisfied, to execute the following cruise control or the constant speed cruise control as an automatic driving control and the driving assistance control.

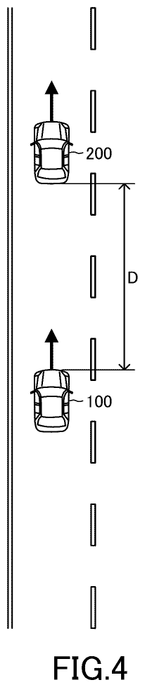

The following cruise control is a control for driving the own vehicle 100 while autonomously or automatically controlling the operation of the driving apparatus 31 and the braking apparatus 32 such that an inter-vehicle distance D is maintained at the set inter-vehicle distance Dset when a preceding vehicle 200 is present as shown in FIG. 4. The preceding vehicle 200 is another vehicle moving in a lane in which the own vehicle 100 is moving, and is another vehicle that is present within a predetermined distance ahead of the own vehicle 100. The inter-vehicle distance D is a distance between the own vehicle 100 and the preceding vehicle 200. The set inter-vehicle distance Dset is a distance set by the driver. The driver can set the set inter-vehicle distance Dset by operating the inter-vehicle distance change switch 56.

When the inter-vehicle distance D becomes longer than the set inter-vehicle distance Dset while the following cruise control is being executed, it becomes necessary to accelerate the own vehicle 100. At this time, the vehicle driving assistance apparatus 10 increases the driving force applied to the own vehicle 100 from the driving apparatus 31 to accelerate the own vehicle 100.

In this embodiment, when the own vehicle speed V increases to the set vehicle speed Vset while the following cruise control is being executed, the vehicle driving assistance apparatus 10 causes the own vehicle 100 to travel while autonomously or automatically controlling the operation of the driving apparatus 31 and the braking apparatus 32 to maintain the own vehicle speed V at the set vehicle speed Vset.

The set vehicle speed Vset is the vehicle speed set by the driver. The driver can increase the set vehicle speed Vset by operating the speed increase switch 54, and can decrease the set vehicle speed Vset by operating the speed decrease switch 55.

On the other hand, when the inter-vehicle distance D becomes shorter than the set inter-vehicle distance Dset while the following cruise control is being executed, it becomes necessary to decelerate the own vehicle 100. At this time, the vehicle driving assistance apparatus 10 reduces the driving force applied to the own vehicle 100 from the driving apparatus 31, or sets the driving force applied to the own vehicle 100 from the driving apparatus 31 to zero and applies the braking force to the own vehicle 100 from the braking apparatus 32, thereby decelerating the own vehicle 100.

The vehicle driving assistance apparatus 10 determines whether or not the preceding vehicle 200 is present based on the surrounding information IS. Further, the vehicle driving assistance apparatus 10 acquires the inter-vehicle distance D based on the surrounding information IS.

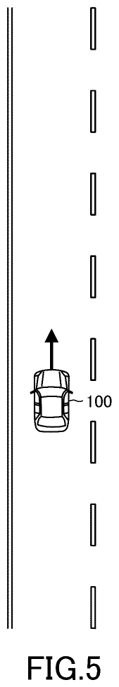

The constant speed cruise control is a control for driving the own vehicle 100 while autonomously or automatically controlling the operation of the driving apparatus 31 and the braking apparatus 32 such that the own vehicle speed V is maintained at the set vehicle speed Vset when there is no preceding vehicle 200 as shown in FIG. 5.

When the own vehicle speed V becomes lower than the set vehicle speed Vset while the constant speed cruise control is being executed, it becomes necessary to accelerate the own vehicle 100. At this time, the vehicle driving assistance apparatus 10 increases the driving force applied to the own vehicle 100 by the driving apparatus 31 to accelerate the own vehicle 100.

On the other hand, when the own vehicle speed V becomes higher than the set vehicle speed Vset while the constant speed cruise control is being executed, it becomes necessary to decelerate the own vehicle 100. At this time, the vehicle driving assistance apparatus 10 reduces the driving force applied to the own vehicle 100 from the driving apparatus 31, or sets the driving force applied to the own vehicle 100 from the driving apparatus 31 to zero and applies the braking force to the own vehicle 100 from the braking apparatus 32, thereby decelerating the own vehicle 100.

The vehicle driving assistance apparatus 10 may be configured to execute a control to assist a steering of the own vehicle 100, such as a lane keeping control, as the driving assistance control. The lane keeping control is a control of autonomously controlling an operation of a steering device of the own vehicle 100 such that the own vehicle 100 travels along a center line of a travel lane, thereby assisting the steering of the own vehicle 100.

At a predetermined timing, the vehicle driving assistance apparatus 10 starts a process from a step S300 of the routine shown in FIG. 3, proceeds with the process to a step S305, and determines whether the change operation is detected.

The change operation is performed by the driver to request the vehicle driving assistance apparatus 10 to change the execution state of the driving assistance control. In this embodiment, the change operation includes the start operation (i.e., the operation requesting to start the driving assistance control), the cancel operation (i.e., the operation requesting to cancel or stop the driving assistance control), the resume operation (i.e., the operation requesting to restart the stopped driving assistance control), the speed increase operation (i.e., the operation requesting to increase the set vehicle speed Vset), the speed decrease operation (i.e., the operation requesting to decrease the set vehicle speed Vset), and the inter-vehicle distance operation (i.e., the operation requesting to change the set inter-vehicle distance Dset).

When the vehicle driving assistance apparatus 10 detects the change operation, the vehicle driving assistance apparatus 10 determines “Yes” at the step S305, proceeds to a step S310, and acquires a first erroneous operation probability P1.

The first erroneous operation probability P1 is an index value indicating a possibility that the driver erroneously performed the change operation. The first erroneous operation probability P1 increases as the possibility that the driver erroneously performed the change operation increases. The first erroneous operation probability P1 decreases as a recommendation degree increases. The recommendation degree is a degree to which it is recommended to change the execution state of the driving assistance control requested by the change operation on a road on which the own vehicle 100 is moving at the time of currently detecting the change operation.

Specifically, the vehicle driving assistance apparatus 10 acquires the first erroneous operation probability P1 as follows.

That is, in this embodiment, multiple types of roads on which vehicles may travel are preselected as predetermined roads Rset. The roads preselected as the predetermined roads Rset include, for example, a road on which a vehicle turning right or left travels, a curved road, a parking lot, and a main road of a highway.

The first erroneous operation probability P1 is preset for each combination of the type of road and the type of change operation, and is stored in the storage medium.

For example, when (i) the road on which the own vehicle 100 is moving at the time of currently detecting the change operation is the predetermined road Rset, and (ii) the type of the road is one that it is not desirable to change the execution state of the driving assistance control as requested by the detected change operation (i.e., when the recommendation degree is low), the first erroneous operation probability P1 corresponding to the combination of the type of the road and the type of the detected change operation is set to a relatively great value.

On the other hand, when (i) the road on which the own vehicle 100 is moving at the time of currently detecting the change operation is the predetermined road Rset, and (ii) the road is one that it is desirable to change the execution state of the driving assistance control as requested by the detected change operation (i.e., when the recommendation degree is high), the first erroneous operation probability P1 corresponding to the combination of the type of the road and the type of the detected change operation is set to a relatively small value.

The vehicle driving assistance apparatus 10 acquires the type of road on which the own vehicle 100 is moving upon detecting the change operation, and acquires from the storage medium the first erroneous operation probability P1 corresponding to the combination of the acquired type of the road and the type of the detected change operation. The vehicle driving assistance apparatus 10 acquires the type of road on which the own vehicle 100 is moving based on the surrounding information IS and a travelling state of the own vehicle 100, such as a driving state, a braking state, and a steering state of the own vehicle 100.

Next, the vehicle driving assistance apparatus 10 proceeds with the process to a step S315 and acquires a second erroneous operation probability P2.

The second erroneous operation probability P2 is an index value indicating the possibility that the driver erroneously performed the change operation. The second erroneous operation probability P2 increases as the probability that the driver erroneously performed the change operation increases. In this embodiment, the second erroneous operation probability P2 decreases as a market operation frequency increases. The market operation frequency is one with which the operation requesting the change of the same type as the change in the execution state of the driving assistance control requested by the currently detected change operation was performed in the past by drivers of other vehicles on the roads of the same type as the road on which the own vehicle 100 is moving at the time of currently detecting the change operation.

Specifically, the vehicle driving assistance apparatus 10 acquires the second erroneous operation probability P2 as follows.

That is, the vehicle driving assistance apparatus 10 acquires the number of times that the other vehicle traveled on the predetermined road Rset in the past as a market travelling number Ntr_m for each type of predetermined road Rset. Furthermore, the vehicle driving assistance apparatus 10 acquires the number of times that the change operation was performed by the driver of the other vehicle while the other vehicle was moving on the predetermined road Rset in the past as a market operation number Nop_m for each type of change operation and for each type of predetermined road Rset.

The vehicle driving assistance apparatus 10 then acquires a value acquired by dividing the market operation number Nop_m by the market travelling number Ntr_m for each predetermined road Rset of the same type and for each change operation of the same type as the market operation frequency for each combination of the same type of predetermined road Rset and the same type of change operation.

The vehicle driving assistance apparatus 10 then acquires the second erroneous operation probability P2 for each combination of the same type of predetermined road Rset and the same type of change operation based on the acquired market operation frequency, and stores the acquired second erroneous operation probability P2 in the storage medium. Here, the second erroneous operation probability P2 corresponding to each combination of the type of road and the type of change operation decreases as the market operation frequency increases.

Therefore, the second erroneous operation probability P2 acquired when the change operation is detected while the own vehicle 100 is moving on the predetermined road Rset, decreases as the frequently with which the driver of the other vehicle performed the operation requesting the change of the same type as the change in the execution state of the driving assistance control requested by the currently detected change operation when the other vehicle was moving in the past on the road of the same type as the predetermined road Rset on which the own vehicle 100 is moving, increases.

For example, the second erroneous operation probability P2 acquired when the start operation requesting to start the driving assistance control is detected while the own vehicle 100 is moving on a curved road, decreases as the frequency with which the driver of the other vehicle performed the start operation requesting to start the driving assistance control when the other vehicle was moving on the curved road in the past, increases.

When the vehicle driving assistance apparatus 10 detects the change operation, the vehicle driving assistance apparatus 10 acquires the type of road on which the own vehicle 100 is currently moving, and acquires the second erroneous operation probability P2 corresponding to the combination of the acquired type of road and the type of the currently detected change operation from the storage medium.

In this embodiment, the vehicle driving assistance apparatus 10 acquires data on the market travelling number Ntr_m and the market operation number Nop_m from an external device via wireless communication.

Then, the vehicle driving assistance apparatus 10 proceeds with the process to a step S320 and acquires a third erroneous operation probability P3.

The third erroneous operation probability P3 is an index value indicating the possibility that the driver erroneously performed the change operation. The third erroneous operation probability P3 increases as the possibility that the driver erroneously performed the change operation increases. In this embodiment, the third erroneous operation probability P3 decreases as a driver operation frequency increases. The driver operation frequency is one with which the driver of the own vehicle 100 performed the same change operation in the past as the currently detected change operation on the road of the same type as the road on which the own vehicle 100 is moving at the time of currently detecting the change operation.

Specifically, the vehicle driving assistance apparatus 10 acquires the third erroneous operation probability P3 as follows.

That is, the vehicle driving assistance apparatus 10 acquires the number of times that the own vehicle 100 traveled on the predetermined road Rset in the past as an own vehicle travelling number Ntr_d for each type of predetermined road Rset. Furthermore, the vehicle driving assistance apparatus 10 acquires the number of times that the change operation was performed by the driver of the own vehicle 100 while the own vehicle 100 was moving on the predetermined road Rset in the past as a driver operation number Nop_d for each type of change operation and for each type of predetermined road Rset.

The vehicle driving assistance apparatus 10 then acquires a value acquired by dividing the driver operation number Nop_d by the own vehicle travelling number Ntr_d for each predetermined road Rset of the same type and for each change operation of the same type as the driver operation frequency for each combination of the same type of predetermined road Rset and the same type of change operation.

The vehicle driving assistance apparatus 10 then acquires the third erroneous operation probability P3 for each combination of the same type of predetermined road Rset and the same type of change operation based on the acquired driver operation frequency, and stores the acquired third erroneous operation probability P3 in the storage medium. Here, the third erroneous operation probability P3 corresponding to each combination of the type of road and the type of change operation decreases as the driver operation frequency increases.

Therefore, the third erroneous operation probability P3 acquired when the change operation is detected while the own vehicle 100 is moving on the predetermined road Rset, decreases as the frequency with which the same change operation as the currently detected change operation was performed by the driver of the own vehicle 100 when the own vehicle 100 was moving in the past on the road of the same type as the predetermined road Rset on which the own vehicle 100 is currently moving, increases.

For example, the third erroneous operation probability P3 acquired when the start operation requesting to start the driving assistance control is detected while the own vehicle 100 is moving on the curved road, decreases as the frequency with which the start operation requesting to start the driving assistance control was performed by the driver of the own vehicle 100 while the own vehicle 100 was moving on the curved road in the past, increases.

When the vehicle driving assistance apparatus 10 detects the change operation, the vehicle driving assistance apparatus 10 acquires the type of road on which the own vehicle 100 is moving, and acquires the third erroneous operation probability P3 corresponding to the combination of the acquired type of road and the type of the currently detected change operation from the storage medium.

The vehicle driving assistance apparatus 10 may be configured to acquire the third erroneous operation probability P3 as follows.

That is, the vehicle driving assistance apparatus 10 acquires the number of times that the approval request notification described below was performed to the driver of the own vehicle 100 due to the change operation being performed by the driver of the own vehicle 100 while the own vehicle 100 was moving on the predetermined road Rset in the past as an approval request notification number Nno_ap for each type of change operation and for each type of predetermined road Rset, and acquires the number of times that the driver of the own vehicle 100 performed an approval operation in response to the approval request notification as an approval operation number Nop_ap for each type of change operation and for each predetermined road Rset.

Then, the vehicle driving assistance apparatus 10 acquires a value acquired by dividing the approval operation number Nop_ap by the approval request notification number Nno_ap for each predetermined road Rset of the same type and for each change operation of the same type as the driver approval frequency for each combination of the same type of predetermined road Rset and the same type of change operation.

The vehicle driving assistance apparatus 10 then acquires the third erroneous operation probability P3 for each combination of the same type of predetermined road Rset and the same type of change operation based on the acquired driver approval frequency, and stores the acquired third erroneous operation probability P3 in the storage medium. Here, the third erroneous operation probability P3 corresponding to each combination of the predetermined road Rset and the change operation decreases as the driver approval frequency increases.

Therefore, the third erroneous operation probability P3 acquired when the change operation is detected while the own vehicle 100 is moving on the predetermined road Rset, decreases as the frequency with which the driver of the own vehicle 100 performed the approval operation in the past when the driver of the own vehicle 100 performed the change operation of the same type as the currently detected change operation while the own vehicle 100 was moving on the road of the same type as the predetermined road Rset on which the own vehicle 100 is currently moving, increases.

For example, the third erroneous operation probability P3 acquired when the start operation requesting to start the driving assistance control is detected while the own vehicle 100 is moving on the curved road, decreases as the frequency with which the driver of the own vehicle 100 performed the approval operation in response to the approval request notification performed in the past due to the driver of the own vehicle 100 performing the start operation requesting to start the driving assistance control while the own vehicle 100 was moving on the curved road, increases.

The vehicle driving assistance apparatus 10 acquires the type of road on which the own vehicle 100 is moving upon detecting the change operation, and acquires the third erroneous operation probability P3 corresponding to the combination of the currently acquired type of the road and the type of the currently detected change operation from the storage medium.

The vehicle driving assistance apparatus 10 then proceeds with the process to a step S325 and acquires an erroneous operation probability P.

The erroneous operation probability P is the sum of (i) a value (=P1·k1) acquired by multiplying the first erroneous operation probability P1 acquired at the step S310 by a first coefficient k1, (ii) a value (=P2·k2) acquired by multiplying the second erroneous operation probability P2 acquired at the step S315 by a second coefficient k2, and (iii) a value (=P3·k3) acquired by multiplying the third erroneous operation probability P3 acquired at the step S320 by a third coefficient k3(P=P1·k1+P2·k2+P3·k3).

Therefore, the erroneous operation probability P is an index value indicating the possibility that the driver erroneously performed the change operation. The erroneous operation probability P increases as the possibility that the driver erroneously performed the change operation increases.

The first coefficient k1, the second coefficient k2, and the third coefficient k3 are used to calculate the erroneous operation probability P by weighting the first erroneous operation probability P1, the second erroneous operation probability P2, and the third erroneous operation probability P3, respectively. The first coefficient k1, the second coefficient k2, and the third coefficient k3 may be set appropriately depending on which of the recommendation degree, the market operation frequency, and the driver operation frequency is to be emphasized when determining whether the change operation is the erroneous operation.

In this embodiment, the first coefficient k1, the second coefficient k2, and the third coefficient k3 are set such that their sum is “1”. In this embodiment, the third coefficient k3 is set to a value greater than the first coefficient k1 and the second coefficient k2. That is, the first coefficient k1, the second coefficient k2, and the third coefficient k3 are set such that the most important factor is the driver operation frequency when determining whether or not the change operation is the erroneous operation.

The vehicle driving assistance apparatus 10 determines that there is a low possibility that the driver of the own vehicle 100 erroneously performed the change operation when the erroneous operation probability P is equal to or less than a small erroneous operation probability Ps. Further, the vehicle driving assistance apparatus 10 determines that there is a medium possibility that the driver of the own vehicle 100 erroneously performed the change operation when the erroneous operation probability P is greater than the small erroneous operation probability Ps and equal to or less than a great erroneous operation probability Pg. Furthermore, the vehicle driving assistance apparatus 10 determines that there is a high possibility that the driver of the own vehicle 100 erroneously performed the change operation when the erroneous operation probability P is greater than the great erroneous operation probability Pg.

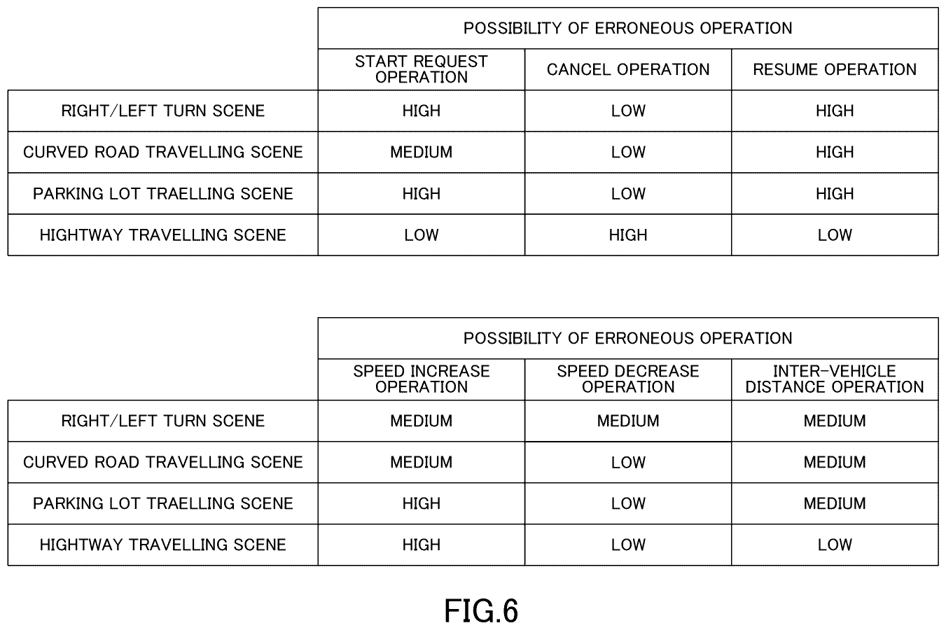

Accordingly, for example, as shown in FIG. 6, when the start operation (i.e., the change operation requesting to start the driving assistance control) is detected in a right/left turn scene (i.e., a scene in which the own vehicle 100 is turning right or left), the erroneous operation probability P is greater than the great erroneous operation probability Pg, and the vehicle driving assistance apparatus 10 determines that the possibility of the erroneous operation (i.e., the possibility that the change operation was performed erroneously) is high. Also, when the start operation is detected in a curved road travelling scene (i.e., a scene in which the own vehicle 100 is travelling on the curved road), the erroneous operation probability P is greater than the small erroneous operation probability Ps and equal to or less than the great erroneous operation probability Pg, and the vehicle driving assistance apparatus 10 determines that the possibility of the erroneous operation is medium. Also, when the start operation is detected in a parking lot travelling scene (i.e., a scene in which the own vehicle 100 is travelling in the parking lot), the erroneous operation probability P is greater than the great erroneous operation probability Pg, and the vehicle driving assistance apparatus 10 determines that the possibility of the erroneous operation is high. Furthermore, when the start operation is detected in a highway travelling scene (i.e., a scene in which the own vehicle 100 is travelling in the main road of the highway), the erroneous operation probability P is equal to or less than the small erroneous operation probability Ps, and the vehicle driving assistance apparatus 10 determines that the possibility of erroneous operation is low.

Furthermore, when the cancel operation (i.e., the change operation requesting to cancel or stop the driving assistance control) is detected in the right/left turn scene, the erroneous operation probability P is equal to or less than the small erroneous operation probability Ps, and the vehicle driving assistance apparatus 10 determines that the possibility of the erroneous operation is low. Furthermore, when the cancel operation is detected in the curved road travelling scene, the erroneous operation probability P is equal to or less than the small erroneous operation probability Ps, and the vehicle driving assistance apparatus 10 determines that the possibility of the erroneous operation is low. Furthermore, when the cancel operation is detected in the parking lot travelling scene, the erroneous operation probability P is equal to or less than the small erroneous operation probability Ps, and the vehicle driving assistance apparatus 10 determines that the possibility of the erroneous operation is low. Furthermore, when the cancel operation is detected in the highway travelling scene, the erroneous operation probability P is greater than the great erroneous operation probability Pg, and the vehicle driving assistance apparatus 10 determines that the possibility of the erroneous operation is high.

Furthermore, when the resume operation (i.e., the change operation requesting to resume the driving assistance control) is detected in the right/left turn scene, the erroneous operation probability P is greater than the great erroneous operation probability Pg, and the vehicle driving assistance apparatus 10 determines that the possibility of the erroneous operation is high. Furthermore, when the resume operation is detected in the curved road travelling scene, the erroneous operation probability P is greater than the great erroneous operation probability Pg, and the vehicle driving assistance apparatus 10 determines that the possibility of the erroneous operation is high. Furthermore, when the resume operation is detected in the parking lot travelling scene, the erroneous operation probability P is greater than the great erroneous operation probability Pg, and the vehicle driving assistance apparatus 10 determines that the possibility of the erroneous operation is high. Furthermore, when the resume operation is detected in the highway travelling scene, the erroneous operation probability P is equal to or less than the small erroneous operation probability Ps, and the vehicle driving assistance apparatus 10 determines that the possibility of the erroneous operation is low.

Furthermore, when the speed increase operation (i.e., the change operation requesting to increase the set vehicle speed Vset) is detected in the right or left turn scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the speed increase operation is detected in the curved road travelling scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the speed increase operation is detected in the parking lot travelling scene, the erroneous operation probability P is greater than the great erroneous operation probability Pg, and the vehicle driving assistance apparatus 10 determines that the possibility of the erroneous operation is high. Furthermore, when the speed increase operation is detected in the highway travelling scene, the erroneous operation probability P is greater than the great erroneous operation probability Pg, and the vehicle driving assistance apparatus 10 determines that the possibility of the erroneous operation is high.

Furthermore, when the speed decrease operation (i.e., the change operation requesting to decrease the set vehicle speed Vset) is detected in the right/left turn scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the speed decrease operation is detected in the curved road travelling scene, the erroneous operation probability P is equal to or less than the small erroneous operation probability Ps, and the vehicle driving assistance apparatus 10 determines that the possibility of the erroneous operation is low. Furthermore, when the speed decrease operation is detected in the parking lot travelling scene, the erroneous operation probability P is equal to or less than the small erroneous operation probability Ps, and the vehicle driving assistance apparatus 10 determines that the possibility of the erroneous operation is low. Furthermore, when the speed decrease operation is detected in the highway travelling scene, the erroneous operation probability P is equal to or less than the small erroneous operation probability Ps, and the vehicle driving assistance apparatus 10 determines that the possibility of the erroneous operation is low.

Furthermore, when the inter-vehicle distance operation (i.e., the change operation requesting to change the set inter-vehicle distance Dset) is detected in the right/left turn scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the inter-vehicle distance operation is detected in the curved road travelling scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the inter-vehicle distance operation is detected in the parking lot travelling scene, the erroneous operation probability P is greater than the small erroneous operation probability Ps and is equal to or less than the great erroneous operation probability Pg, and the vehicle driving assistance apparatus 10 determines that the possibility of the erroneous operation is medium. Furthermore, when the inter-vehicle distance operation is detected in the highway travelling scene, the erroneous operation probability P is equal to or less than the small erroneous operation probability Ps, and the vehicle driving assistance apparatus 10 determines that the possibility of the erroneous operation is low.

More specifically, after the vehicle driving assistance apparatus 10 acquires the erroneous operation probability P at the step S325, the vehicle driving assistance apparatus 10 proceeds with the process to a step S330 and determines whether a small probability condition Cs is satisfied.

The small probability condition Cs is satisfied when the erroneous operation probability P is equal to or less than the small erroneous operation probability Ps(P≤Ps). That is, the small probability condition Cs is satisfied when the possibility that the driver of the own vehicle 100 erroneously performed the change operation is low.

When the small probability condition Cs is satisfied, the vehicle driving assistance apparatus 10 determines “Yes” at the step S330, proceeds with the process to a step S335, and executes a small probability process. After that, the vehicle driving assistance apparatus 10 proceeds with the process to a step S395 and terminates the process of this routine once.

The small probability process executed at the step S335 is as follows.

For example, in the situation where the change operation is the operation requesting to start the following cruise control, the small probability process is a process of starting the following cruise control. That is, the small probability process is a process of executing the normal following cruise control.

Also, in the situation where the change operation is the operation requesting to stop (or cancel) the following cruise control, the small probability process is a process of stopping the following cruise control.

Also, in the situation where the change operation is the operation requesting to start the constant speed cruise control, the small probability process is a process of starting the constant speed cruise control. That is, the small probability process is a process of executing the normal constant speed cruise control.

Furthermore, in the situation where the change operation is the operation requesting to stop (or cancel) the constant speed cruise control, the small probability process is a process of stopping the constant speed cruise control.

In this way, when the erroneous operation probability P is equal to or less than a predetermined erroneous operation probability (in this embodiment, the small erroneous operation probability Ps) when the vehicle driving assistance apparatus 10 detects the change operation (in this embodiment, the operation requesting to start or stop the following cruise control or the constant speed cruise control), the vehicle driving assistance apparatus 10 changes the execution state of the driving assistance control (in this embodiment, starts or stops the following cruise control or the constant speed cruise control) in accordance with the request by the detected change operation (in this embodiment, the request to start or stop the following cruise control, or the request to start or stop the constant speed cruise control).

In addition, in the situation where the change operation is the resume operation (for example, the operation requesting to resume the following cruise control or the constant speed cruise control), when the erroneous operation probability P is equal to or less than the predetermined erroneous operation probability (for example, the small erroneous operation probability Ps) when the vehicle driving assistance apparatus 10 detects the change operation, the vehicle driving assistance apparatus 10 changes the execution state of the driving assistance control (for example, resumes the following cruise control or the constant speed cruise control) as requested by the detected change operation.

Alternatively, in the situation where the change operation is the speed increase operation, the speed decrease operation, or the inter-vehicle distance operation (for example, the operation requesting to increase the set vehicle speed Vset, the operation requesting to decrease the set vehicle speed Vset, or the operation requesting to change the set inter-vehicle distance Dset), when the erroneous operation probability P is equal to or less than the predetermined erroneous operation probability (for example, the small erroneous operation probability Ps) when the vehicle driving assistance apparatus 10 detects the change operation, the vehicle driving assistance apparatus 10 changes the execution state of the driving assistance control as requested by the detected change operation (for example, increases the set vehicle speed Vset by an increase amount requested by the detected speed increase operation, decreases the set vehicle speed Vset by a decrease amount requested by the detected speed decrease operation, or changes the set inter-vehicle distance Dset by a change amount requested by the detected inter-vehicle distance operation).

On the other hand, when the small probability condition Cs is not satisfied, the vehicle driving assistance apparatus 10 determines “No” at the step S330, proceeds with the process to a step S340, and determines whether a great probability condition Cg is satisfied or not.

The great probability condition Cg is satisfied when the erroneous operation probability P is greater than the great erroneous operation probability Pg(P>Pg). That is, the great probability condition Cg is satisfied when there is a high possibility that the driver of the own vehicle 100 erroneously performed the change operation.

When the great probability condition Cg is satisfied, the vehicle driving assistance apparatus 10 determines “Yes” at the step S340, proceeds with the process to a step S345, and executes a great probability process. Then, the vehicle driving assistance apparatus 10 proceeds with the process to the step S395, and terminates the process of this routine once. The great probability process executed at the step S345 is as follows.

For example, in the situation where the change operation is the operation requesting to start the following cruise control, and a travelling scene of the own vehicle 100 is an acceleration request scene, the great probability process is a process of performing the approval request notification to the driver without starting the following cruise control. The acceleration request scene here is one in which, when the following cruise control is started in response to the change operation, it is necessary to accelerate the own vehicle 100 by the following cruise control. The approval request notification performed at this time requests the driver to approve the starting of the following cruise control (i.e., the change in the execution state of the driving assistance control). In this case, when the vehicle driving assistance apparatus 10 detects the approval operation (i.e., when the driver performs the approval operation), the vehicle driving assistance apparatus 10 starts the following cruise control. On the other hand, when the vehicle driving assistance apparatus 10 detects the denial operation (i.e., the driver performs the denial operation), the vehicle driving assistance apparatus 10 does not start the following cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to start the following cruise control), the vehicle driving assistance apparatus 10 does not change the execution state of the driving assistance control (in this embodiment, does not start the following cruise control).

Furthermore, in this case, when the vehicle driving assistance apparatus 10 determines not to change the execution state of the driving assistance control upon detecting the change operation, the vehicle driving assistance apparatus 10 performs the approval request notification to the driver of the own vehicle 100 to request an approval for changing the execution state. In this case, the vehicle driving assistance apparatus 10 changes the execution state when the driver of the own vehicle 100 approves the change in the execution state.

Furthermore, for example, in the situation where the change operation is the operation requesting to start the following cruise control and the travelling scene of the own vehicle 100 is a deceleration request scene, the great probability process is a process of performing a start notification, starting the following cruise control, and accelerating the own vehicle 100 at a standard acceleration rate Ga_s. That is, the great probability process is a process of performing the start notification and executing the normal following cruise control. The deceleration request scene here is one in which, when the following cruise control is started in response to the change operation, it is necessary to decelerate the own vehicle 100 by the following cruise control. The start notification performed at this time notifies the driver that the following cruise control will be started.

The standard acceleration rate Ga_s for the following cruise control is the normal acceleration rate for accelerating the own vehicle 100 by the following cruise control.

Furthermore, for example, in the situation where the change operation is the operation requesting to stop (or cancel) the following cruise control and the travelling scene of the own vehicle 100 is one in which the preceding vehicle 200 is present, the great probability process is a process of performing the approval request notification to the driver without stopping the following cruise control. The approval request notification performed at this time requests the driver to approve the stopping of the following cruise control (i.e., the change in the execution state of the driving assistance control). In this case, when the vehicle driving assistance apparatus 10 detects the approval operation (i.e., the driver performs the approval operation), the vehicle driving assistance apparatus 10 stops the following cruise control. On the other hand, when the vehicle driving assistance apparatus 10 detects the denial operation (i.e., the driver performs the denial operation), the vehicle driving assistance apparatus 10 does not stop the following cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the following cruise control), the vehicle driving assistance apparatus 10 does not change the execution state of the driving assistance control (in this embodiment, does not stop the following cruise control).

Furthermore, in this case, when the vehicle driving assistance apparatus 10 determines not to change the execution state of the driving assistance control upon detecting the change operation, the vehicle driving assistance apparatus 10 performs the approval request notification to the driver of the own vehicle 100 to request the approval for changing the execution state. In this case, the vehicle driving assistance apparatus 10 changes the execution state when the driver of the own vehicle 100 approves the change in the execution state.

Furthermore, for example, in the situation where the change operation is the operation requesting to stop (or cancel) the following cruise control and the travelling scene of the own vehicle 100 is one in which the preceding vehicle 200 is not present, the great probability process is a process of performing the approval request notification to the driver without stopping the following cruise control. The approval request notification performed at this time requests the driver to approve the stopping of the following cruise control (i.e., the change in the execution state of the driving assistance control). In this case, when the vehicle driving assistance apparatus 10 detects the approval operation (i.e., the driver performs the approval operation), the vehicle driving assistance apparatus 10 stops the following cruise control. On the other hand, when the vehicle driving assistance apparatus 10 detects the denial operation (i.e., the driver performs the denial operation), the vehicle driving assistance apparatus 10 does not stop the following cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the following cruise control), the vehicle driving assistance apparatus 10 does not change the execution state of the driving assistance control (in this embodiment, does not stop the following cruise control).

Furthermore, in this case, when the vehicle driving assistance apparatus 10 determines not to change the execution state of the driving assistance control upon detecting the change operation, the vehicle driving assistance apparatus 10 performs the approval request notification to the driver of the own vehicle 100 to request the approval for changing the execution state. In this case, the vehicle driving assistance apparatus 10 changes the execution state when the driver of the own vehicle 100 approves the change in the execution state.

Furthermore, for example, in the situation where the change operation is the operation requesting to start the constant speed cruise control and the travelling scene of the own vehicle 100 is the acceleration request scene, the great probability process is a process of performing the approval request notification to the driver without starting the constant speed cruise control. The acceleration request scene here is one in which, when the constant speed cruise control is started in response to the change operation, it is necessary to accelerate the own vehicle 100 by the constant speed cruise control. The approval request notification performed at this time requests the driver to approve the starting of the constant speed cruise control (i.e., the change in the execution state of the driving assistance control). In this case, when the vehicle driving assistance apparatus 10 detects the approval operation (i.e., the driver performs the approval operation), the vehicle driving assistance apparatus 10 starts the constant speed cruise control. On the other hand, when the vehicle driving assistance apparatus 10 detects the denial operation (i.e., the driver performs the denial operation), the vehicle driving assistance apparatus 10 does not start the constant speed cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to start the constant speed cruise control), the vehicle driving assistance apparatus 10 does not change the execution state of the driving assistance control (in this embodiment, does not start the constant speed cruise control).

Furthermore, in this case, when the vehicle driving assistance apparatus 10 determines not to change the execution state of the driving assistance control upon detecting the change operation, the vehicle driving assistance apparatus 10 performs the approval request notification to the driver of the own vehicle 100 to request the approval for changing the execution state. In this case, the vehicle driving assistance apparatus 10 changes the execution state when the driver of the own vehicle 100 approves the change in the execution state.

Furthermore, for example, in the situation where the change operation is the operation requesting to start the constant speed cruise control and the travelling scene of the own vehicle 100 is a deceleration request scene, the great probability process is a process of performing the start notification, starting the constant speed cruise control, and decelerating the own vehicle 100 at a standard deceleration rate Gd_s. That is, the great probability process is a process of performing the start notification and executing the normal constant speed cruise control. The deceleration request scene here is one in which, when the constant speed cruise control is started in response to the change operation, it is necessary to decelerate the own vehicle 100 by the constant speed cruise control. The start notification performed at this time notifies the driver that the constant speed cruise control will be started.

The standard deceleration rate Gd_s for the constant speed cruise control is the normal deceleration rate of the own vehicle 100 realized by the constant speed cruise control.

Furthermore, for example, in the situation where the change operation is the operation requesting to stop (or cancel) the constant speed cruise control, the great probability process is a process of performing the approval request notification to the driver without stopping the constant speed cruise control, regardless of the travelling scene of the own vehicle 100. The approval request notification performed at this time requests the driver to approve the stopping of the constant speed cruise control (i.e., the change in the execution state of the driving assistance control). In this case, when the vehicle driving assistance apparatus 10 detects the approval operation (i.e., the driver performs the approval operation), the vehicle driving assistance apparatus 10 stops the constant speed cruise control. On the other hand, when the vehicle driving assistance apparatus 10 detects the denial operation (i.e., the driver performs the denial operation), the vehicle driving assistance apparatus 10 does not stop the constant speed cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the constant speed cruise control), the vehicle driving assistance apparatus 10 does not change the execution state of the driving assistance control (in this embodiment, does not stop the constant speed cruise control).

In this case, when the vehicle driving assistance apparatus 10 determines not to change the execution state of the driving assistance control upon detecting the change operation, the vehicle driving assistance apparatus 10 performs the approval request notification to the driver of the own vehicle 100 to request the approval for changing the execution state. In this case, when the driver of the own vehicle 100 approves the change in the execution state, the vehicle driving assistance apparatus 10 changes the execution state.

On the other hand, when the great probability condition Cg is not satisfied, the vehicle driving assistance apparatus 10 determines “No” at the step S340, proceeds with the process to a step S350, and executes a medium probability process. Then, the vehicle driving assistance apparatus 10 proceeds with the process to the step S395 and terminates the process of this routine once.

The medium probability process executed at the step S350 is as follows.

For example, in the situation where the change operation is the operation requesting to start the following cruise control and the travelling scene of the own vehicle 100 is the acceleration request scene, the medium probability process is a process of performing the start notification, starting the following cruise control, and accelerating the own vehicle 100 at an acceleration rate smaller than the standard acceleration rate Ga_s. That is, the medium probability process is a process of performing the start notification, starting the following cruise control, and gradually accelerating the own vehicle 100. The acceleration request scene here is one in which, when the following cruise control is started in response to the change operation, it is necessary to accelerate the own vehicle 100 by the following cruise control. The start notification performed at this time notifies the driver that the following cruise control will be started.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to start the following cruise control), the vehicle driving assistance apparatus 10 performs the more gradual change in the execution state of the driving assistance control (in this embodiment, the starting of the following cruise control and the acceleration at the smaller acceleration rate than the standard acceleration rate Ga_s) than the change in the execution state of the driving assistance control requested by the currently detected change operation (in this embodiment, the starting of the following cruise control and the acceleration at the standard acceleration rate Ga_s).

In this case, when the vehicle driving assistance apparatus 10 determines to perform the more gradual change in the execution state of the driving assistance control than the change in the execution state of the driving assistance control requested by the detected change operation, the vehicle driving assistance apparatus 10 notifies the driver of the own vehicle 100 that the execution state of the driving assistance control will be changed (in this embodiment, the following cruise control will be started).

Also, in this case, in the situation where the change operation requests a change in a control amount for the own vehicle 100 by the driving assistance control (in this embodiment, a change in the acceleration rate of the own vehicle 100 realized by the following cruise control from zero to the standard acceleration rate Ga_s) and the vehicle driving assistance apparatus 10 determines to perform the more gradual change in the execution state of the driving assistance control than the change in the execution state of the driving assistance control requested by the detected change operation upon detecting the change operation, the vehicle driving assistance apparatus 10 changes the control amount to a smaller degree than requested by the detected change operation (in this embodiment, to change the acceleration rate of the own vehicle 100 by the following cruise control from zero to an acceleration rate smaller than the standard acceleration rate Ga_s).

In the situation where the change operation is the speed increase operation, the speed decrease operation, or the inter-vehicle distance operation, when the erroneous operation probability P is equal to or less than the predetermined erroneous operation probability (for example, the small erroneous operation probability Ps) when the vehicle driving assistance apparatus 10 detects the change operation, the vehicle driving assistance apparatus 10 changes the control amount to a smaller degree than requested by the detected change operation (in this embodiment, increases the set vehicle speed Vset by an amount smaller than requested by the detected speed increase operation, decreases the set vehicle speed Vset by an amount smaller than requested by the detected speed decrease operation, or changes the set following distance Dset by an amount smaller than requested by the detected inter-vehicle distance operation).

Furthermore, for example, in the situation where the change operation is the operation requesting to start the following distance control and the travelling scene of the own vehicle 100 is the deceleration request scene, the medium probability process is a process of performing the start notification, starting the following distance control, and decelerating the own vehicle 100 at the standard deceleration rate Gd_s. That is, the medium probability process is a process of performing the start notification and executing the normal following cruise control. The deceleration request scene here is one in which, when the following cruise control is started in response to the detected change operation, it is necessary to decelerate the own vehicle 100 by the following cruise control. The start notification performed at this time notifies the driver that the following cruise control will be started.

The standard deceleration rate Gd_s here is the normal deceleration rate realized when the own vehicle 100 is decelerated by the started following cruise control.

For example, in the situation where the change operation is the operation requesting to stop (or cancel) the following cruise control and the travelling scene of the own vehicle 100 is one in which the preceding vehicle 200 is present, the medium probability process is a process of performing the approval request notification to the driver without stopping the following cruise control. The approval request notification performed at this time requests the driver to approve the stopping of the following cruise control (i.e., the change in the execution state of the driving assistance control). In this case, when the vehicle driving assistance apparatus 10 detects the approval operation (i.e., the driver performs the approval operation), the vehicle driving assistance apparatus 10 stops the following cruise control. On the other hand, when the vehicle driving assistance apparatus 10 detects the denial operation (i.e., the driver performs the denial operation), the vehicle driving assistance apparatus 10 does not stop the following cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the following cruise control), the vehicle driving assistance apparatus 10 does not change the execution state of the driving assistance control (in this embodiment, does not stop the following cruise control).

In this case, when the vehicle driving assistance apparatus 10 determines not to change the execution state of the driving assistance control upon detecting the change operation, the vehicle driving assistance apparatus 10 performs the approval request notification to the driver of the own vehicle 100 to request the approval for changing the execution state. In this case, the vehicle driving assistance apparatus 10 changes the execution state when the driver of the own vehicle 100 approves the change in the execution state.

In addition, for example, in the situation where the change operation is the operation requesting to stop (or cancel) the following cruise control and the travelling scene of the own vehicle 100 is one in which the preceding vehicle 200 is not present, the medium probability process is a process of performing a stop notification without stopping the following cruise control, and of stopping the following cruise control when a predetermined time Tth elapses since the stop notification is performed. The stop notification performed at this time notifies the driver that the following cruise control will be stopped.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the following cruise control), the vehicle driving assistance apparatus 10 does not change the execution state of the driving assistance control (in this embodiment, does not stop the following cruise control).

Furthermore, in this case, when the vehicle driving assistance apparatus 10 determines not to change the execution state of the driving assistance control upon detecting the change operation, the vehicle driving assistance apparatus 10 performs a change notification to notify the driver of the own vehicle 100 that the execution state of the driving assistance control will be changed. In this case, the vehicle driving assistance apparatus 10 changes the execution state of the driving assistance control when the predetermined time Tth elapses since the change notification was performed.

For example, in the situation where the change operation is the operation requesting to start the constant speed cruise control and the travelling scene of the own vehicle 100 is the acceleration request scene, the medium probability process is a process of performing the start notification, starting the constant speed cruise control, and accelerating the own vehicle 100 at an acceleration smaller than the standard acceleration rate Ga_s. That is, the medium probability process is a process of performing the start notification, starting the constant speed cruise control, and gradually accelerating the own vehicle 100. The acceleration request scene here is one in which, when the constant speed cruise control is started in response to the detected change operation, it is necessary to accelerate the own vehicle 100 by the constant speed cruise control. The start notification performed at this time notifies the driver that the constant speed cruise control will be started.

The standard acceleration rate Ga_s for the constant speed cruise control is the normal acceleration rate realized by the started constant speed cruise control.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to start the constant speed cruise control), the vehicle driving assistance apparatus 10 performs the more gradual change in the execution state of the driving assistance control (in this embodiment, starts the constant speed cruise control and accelerates the own vehicle 100 at an acceleration rate smaller than the standard acceleration rate Ga_s) than the change in the execution state of the driving assistance control requested by the detected change operation (in this embodiment, starts the constant speed cruise control and accelerates the own vehicle 100 at the standard acceleration rate Ga_s).

In this case, when the vehicle driving assistance apparatus 10 determines to perform the more gradual change in the execution state of the driving assistance control than the change in the execution state of the driving assistance control requested by the change operation, the vehicle driving assistance apparatus 10 notifies the driver of the own vehicle 100 that the execution state of the driving assistance control will be changed.

Also, in this case, in the situation where the change operation is the operation requesting to change the control amount for the own vehicle 100 by the driving assistance control (in this embodiment, to change the acceleration rate of the own vehicle 100 by the constant speed cruise control from zero to the standard acceleration rate Ga_s), and the vehicle driving assistance apparatus 10 determines to perform the more gradual change in the execution state of the driving assistance control than the change in the execution state of the driving assistance control requested by the detected change operation upon detecting the change operation, the vehicle driving assistance apparatus 10 changes the control amount to a smaller degree than the change in the control amount requested by the detected change operation (in this embodiment, changes the acceleration rate of the own vehicle 100 by the constant speed cruise control from zero to an acceleration smaller than the standard acceleration rate Ga_s).

In the situation where the change operation is the speed increase operation or the speed decrease operation, when the erroneous operation probability P is equal to or less than the predetermined erroneous operation probability (for example, the small erroneous operation probability Ps) when the vehicle driving assistance apparatus 10 detects the change operation, the vehicle driving assistance apparatus 10 changes the control amount to a smaller degree than requested by the detected change operation (in this embodiment, increases the set vehicle speed Vset by an amount smaller than requested by the detected speed increase operation, or decreases the set vehicle speed Vset by an amount smaller than requested by the detected speed decrease operation).

Furthermore, for example, in the situation where the change operation is the operation requesting to start the constant speed moving control and the travelling scene of the own vehicle 100 is the deceleration request scene, the medium probability process is a process of performing the start notification, starting the constant speed moving control, and decelerating the own vehicle 100 at the standard deceleration rate Gd_s. That is, the medium probability process is a process of performing the start notification and executing the normal constant speed moving control. The deceleration request scene here is one in which, when the constant speed cruise control is started in response to the detected change operation, it is necessary to decelerate the own vehicle 100 by the constant speed cruise control. The start notification performed at this time notifies the driver that the constant speed cruise control will be started.

For example, in the situation where the change operation is the operation requesting to stop (or cancel) the constant speed cruise control, the medium probability process is a process of performing the stop notification without stopping the constant speed cruise control, and stopping the constant speed cruise control when the predetermined time Tth elapses since the stop notification is performed, regardless of the travelling scene of the own vehicle 100. The stop notification performed at this time notifies the driver that the constant speed cruise control will be stopped.

In this case, when the erroneous operation probability P is greater than the predetermined erroneous operation probability (in this embodiment, the small erroneous operation probability Ps) when the vehicle driving assistance apparatus 10 detects the change operation (in this embodiment, the operation requesting to stop the constant speed cruise control), the vehicle driving assistance apparatus 10 does not change the execution state of the driving assistance control (in this embodiment, does not stop the constant speed cruise control).

Furthermore, in this case, when the vehicle driving assistance apparatus 10 determines not to change the execution state of the driving assistance control upon detecting the change operation, the vehicle driving assistance apparatus 10 performs a change notification to notify the driver of the own vehicle 100 that the execution state of the driving assistance control will be changed. In this case, the vehicle driving assistance apparatus 10 changes the execution state of the driving assistance control when the predetermined time Tth elapses since the change notification is performed.

The above is the operation of the vehicle driving assistance apparatus 10.

The vehicle driving assistance apparatus 10 determines whether to change the execution state of the driving assistance control, or adjusts the manner in which the execution state of the driving assistance control is changed, based on the erroneous operation probability P. The erroneous operation probability P indicates the possibility that the operation requesting to change the execution state of the driving assistance control was erroneously performed by the driver of the own vehicle 100. Therefore, the execution state of the driving assistance control is changed while taking into consideration the possibility that the operation requesting to change the execution state of the driving assistance control was erroneously performed by the driver of the own vehicle 100.

The present invention is not limited to the above embodiments, and various modified examples can be adopted within the scope of the present invention.

What is claimed is:

1. A vehicle driving assistance apparatus comprising an electronic control unit which executes a driving assistance control to assist a driver of an own vehicle in driving operations,
wherein the electronic control unit is configured to:
when (i) the electronic control unit detects a change operation performed by the driver of the own vehicle to request a change in an execution state of the driving assistance control, and (ii) an erroneous operation probability is equal to or less than a predetermined erroneous operation probability, change the execution state as requested by the detected change operation,
the erroneous operation probability indicating a possibility that the driver of the own vehicle erroneously performed the change operation, and increasing as the possibility increases,
when the erroneous operation probability is greater than the predetermined erroneous operation probability upon detecting the change operation, not change the execution state or perform a more gradual change in the execution state than requested by the detected change operation.

2. The vehicle driving assistance apparatus according to claim 1,
wherein the erroneous operation probability decreases as a driver operation frequency increases,
the driver operation frequency being the frequency with which the same change operation as the currently detected change operation was performed in the past by the driver of the own vehicle on the road of the same type as the road on which the own vehicle is moving at the time of currently detecting the change operation, or
wherein the erroneous operation probability decreases as a market operation frequency increases,
the market operation frequency being the frequency with which an operation requesting a change of the same type as the change requested by the currently detected change operation was performed in the past by a driver of another vehicle on the road of the same type as the road on which the own vehicle is moving at the time of currently detecting the change operation, or
wherein the erroneous operation probability decreases as a recommendation degree increases,
the recommendation degree being the degree to which the change requested by the currently detected change operation is recommended on the road on which the own vehicle is moving at the time of currently detecting the change operation.

3. The vehicle driving assistance apparatus according to claim 1,
wherein the electronic control unit is configured to:
when the electronic control unit determines not to change the execution state in response to the erroneous operation probability being greater than the predetermined erroneous operation probability upon detecting the change operation, perform an approval request notification to the driver of the own vehicle to request an approval for changing the execution state; and
when the driver of the own vehicle receiving the approval request notification approves the change in the execution state, change the execution state.

4. The vehicle driving assistance apparatus according to claim 3,
wherein the erroneous operation probability decreases as a driver approval frequency increases,
the driver approval frequency being the frequency with which the driver of the own vehicle approved the change in the past in response to the approval request notification performed in response to detecting the same operation as the currently detected change operation on the roads of the same type as the road on which the own vehicle is moving at the time of currently detecting the change operation.

5. The vehicle driving assistance apparatus according to claim 1, wherein the electronic control unit is configured to notify the driver of the own vehicle that the execution state will be changed when the electronic control unit determines to perform the more gradual change in the execution state than requested by the detected change operation.

6. The vehicle driving assistance apparatus according to claim 1, wherein the electronic control unit is configured to, when (i) the detected change operation is the operation requesting a change in a control amount for the own vehicle by the driving assistance control, and (ii) the electronic control unit determines to perform the more gradual change in the execution state than requested by the detected change operation upon detecting the change operation, change the control amount to a smaller degree than requested by the detected change operation.

7. The vehicle driving assistance apparatus according to claim 1,
wherein the electronic control unit is configured to:
when the electronic control unit determines not to change the execution state in response to the erroneous operation probability being greater than the predetermined erroneous operation probability upon detecting the change operation, perform a change notification to notify the driver of the own vehicle that the execution state will be changed; and
when a predetermined time elapses since the change notification is performed, change the execution state.

8. A vehicle driving assistance method for executing a driving assistance control to assist a driver of an own vehicle in driving operations,
wherein the vehicle driving assistance method comprises steps of:
when an erroneous operation probability is equal to or less than a predetermined erroneous operation probability upon detecting a change operation performed by the driver of the own vehicle to request a change in an execution state of the driving assistance control, changing the execution state as requested by the detected change operation,
the erroneous operation probability indicating a possibility that the driver of the own vehicle erroneously performed the change operation, and increasing as the possibility increases,
when the erroneous operation probability is greater than the predetermined erroneous operation probability upon detecting the change operation, not changing the execution state or perform a more gradual change in the execution state than requested by the detected change operation.

9. A computer-readable storage medium storing a vehicle driving assistance program which executes a driving assistance control to assist a driver of an own vehicle in driving operations,
wherein the vehicle driving assistance program is configured to:
when an erroneous operation probability is equal to or less than a predetermined erroneous operation probability upon detecting a change operation performed by the driver of the own vehicle to request a change in an execution state of the driving assistance control, and (ii), change the execution state as requested by the detected change operation,
the erroneous operation probability indicating a possibility that the driver of the own vehicle erroneously performed the change operation, and increasing as the possibility increases,
when the erroneous operation probability is greater than the predetermined erroneous operation probability upon detecting the change operation, not change the execution state or perform a more gradual change in the execution state than requested by the detected change operation.
